(19) United States
(12) Patent Application Publication
(10) Pub. No.: US 2021/0359498 A1
(43) Pub. Date: Nov. 18, 2021

(54) MODULAR ELECTRICAL POWER DISTRIBUTION PANEL

(71) Applicant: Rosendin Electric, Inc., San Jose, CA (US)

(72) Inventors: William Paul Mazzetti, JR., San Francisco, CA (US); Charles Zhou, Alameda, CA (US); David McFate, San Jose, CA (US)

(73) Assignee: Rosendin Electric, Inc.

(21) Appl. No.: 17/322,236

(22) Filed: May 17, 2021

Related U.S. Application Data
(60) Provisional application No. 63/025,721, filed on May 15, 2020.

(51) Int. Cl. H02B 1/42; H02B 1/44; H02B 3/00

(52) U.S. Cl. CPC H02B 1/42; H02J 4/00; H02B 3/00; H02B 1/44

(57) ABSTRACT

In an operation, the modular electrical power distribution panel (MEPP) is built and assembled with accessories of additional electrical components, instruments, and lighting controls installed in the MEPP. The MEPP can further include bus bars for circuit breakers to attach to as well as electrical rails constructed to allow one or more instruments that will be mounted in the MEPPs to electrically connect to the electrical rails. The MEPP rests on a floor and is supported through its frame from a ground up to be a free standing panel. The MEPP, the bus bars, electrical rails and accessories are modular shippable in five modular pieces or less that meet requirements set by a nationally recognized testing laboratory approval as assembled as a whole unit; and thus, eliminate a need for a second laboratory approval as the whole unit when assembled for a first time at a work site.

### CROSS-REFERENCE

This application claims priority under 35 USC 119 to U.S. provisional patent application Ser. No. 63/025,721, titled “Modular Electrical Power Panel (MEPP),” filed 15 May 2020, which the disclosure of such is incorporated herein by reference in its entirety.

### FIELD OF THE INVENTION

Embodiments of the invention generally relate to a platform for power distribution.

### BACKGROUND

The traditional branch circuit panelboards are that this has been a commodity space for decades. Improvements have been made by contractor shop customization verses factory customization. We have also noticed that the traditional panel's size can make working inside the existing panel space and other dimensions make installation of traditional panels difficult and lengthy. Wall supported branch circuit panels have been wall-mounted or back-mounted for many years.

### SUMMARY

In an embodiment, a modular electrical power distribution panel can be built and assembled as a modular electrical power distribution panel constructed for an electrical rating of 600 voltage or less. The modular electrical power distribution panel can have at least one or more accessories of i) additional electrical components installed in the modular electrical power distribution panel, ii) additional instruments installed in the modular electrical power distribution panel, and iii) additional lighting controls installed in the modular electrical power distribution panel. Typically, the modular electrical power distribution panel can be ordered and customized to have all three. The modular electrical power distribution panel further includes 1) one or more bus bars (or electrical lugs) constructed to allow one or more circuit breakers to attach to so that the one or more circuit breakers can be physically installed on the bus bars, and 2) one or more electrical rails constructed to allow one or more instruments that will be mounted in the modular electrical power distribution panels to electrically connect to the electrical rails.

A construction of the modular electrical power distribution panel is structurally to rest on a floor and is supported through its frame from a ground up to be a free standing panel; rather than, being a panel that is wall mounted. Importantly, the modular electrical power distribution panel, the bus bars, electrical rails and accessories are constructed as a modular unit shippable in five modular pieces or less that is tested and certified in a factory to meet requirements set by a first nationally recognized testing laboratory approval as assembled as a whole unit, such as Electrical Testing Lab, Underwriters Laboratories Inc., etc.; and thus, eliminate a need for a second nationally recognized testing laboratory approval as the whole unit that would be required when installing the modular electrical power distribution panel, the bus bars, the electrical rails and the accessories as separate pieces at a work site.

These and many more embodiments are discussed.

### BRIEF DESCRIPTION OF THE DRAWINGS

The drawings refer to embodiments of the invention in which:

FIG. 1A illustrates a front view diagram of an embodiment of an example structure of the modular electrical power distribution panel having a main body of the modular electrical power distribution panel to house both the bus bars and the electrical rails, as well as a top panel and a bottom panel integrated with the main body of the modular electrical power distribution panel.

FIG. 1B illustrates a diagram of an embodiment of an example front interior view of the modular electrical power distribution panel structurally resting on a floor and supported through its frame from a ground up to be a free standing panel.

FIG. 1C illustrates a diagram of an embodiment of an example front interior view of the modular electrical power distribution panel with integrated parts including i) an enclosure framework of the modular electrical power distribution panel to support the modular electrical power distribution panel to be a free standing structure and ii) an interior panel to house 1) main circuit breakers and branch circuit breakers attached to the one or more bus bars, and 2) internal electrical rails.

FIG. 1D illustrates a diagram of an embodiment of an example front interior view of the modular electrical power distribution panel that has one or more electrical rails for the mounting of instruments installed in the modular electrical power distribution panel including an electrical circuit monitoring instrument.

FIGS. 2A-2D illustrate a flow diagram of an embodiment of an example method of manufacturing a modular electrical power distribution panel and then installing the panel at a work site.

FIG. 3A illustrates a block diagram of an embodiment of an example frame of the modular electrical power distribution panel constructed to have multiple discrete portions making up the frame, which are designed to be mechanically secured together; and thus, capable from a same panel template of both 1) shipping in two or more main physical parts that are assembled mechanically together at the work site as well as 2) can also be shipped all assembled together as a single assembly.

FIG. 3B illustrates a block diagram of an embodiment of an example single panel template used to manufacture the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template.

FIG. 3C illustrates a block diagram of an embodiment of an example single panel template used to manufacture the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template.

FIG. 3D illustrates a block diagram of an embodiment of an example a modular electrical power distribution panel built and assembled for an electrical rating of 600 voltage or less with at least one or more accessories of i) additional electrical components installed in the modular electrical power distribution panel, ii) additional instruments installed in the modular electrical power distribution panel, and iii) additional lighting controls installed in the modular electrical power distribution panel.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, amount of emergency power supplies, etc., in order to provide a thorough understanding of the present invention. It will be apparent, however, to one of ordinary skill in the art that the present invention may be practiced without these specific details. In other instances, well known components or methods have not been described in detail but rather in a block diagram in order to avoid unnecessarily obscuring the present invention. Further specific numeric references such as first enclosure, may be made. However, the specific numeric reference should not be interpreted as a literal sequential order but rather interpreted that the first enclosure is different than a second enclosure. Thus, the specific details set forth are merely exemplary. The specific details may be varied from and still be contemplated to be within the spirit and scope of the present invention.

In general, a modular electrical power distribution panel and other electrical technology is described. In an embodiment, a method of manufacturing a modular electrical power distribution panel is discussed. In an operation, the modular electrical power distribution panel is built and assembled as a modular electrical power distribution panel constructed for an electrical rating of 600 voltage or less with at least one or more accessories of i) additional electrical components installed in the modular electrical power distribution panel, ii) additional instruments installed in the modular electrical power distribution panel, and iii) additional lighting controls installed in the modular electrical power distribution panel. The modular electrical power distribution panel can further include

i) one or more bus bars (and/or electrical lugs) constructed to allow one or more circuit breakers to attach to so that the one or more circuit breakers can be physically installed on the bus bars, and

ii) one or more electrical rails constructed to allow one or more instruments that will be mounted in the modular electrical power distribution panels to electrically connect to the electrical rails.

The construction of the modular electrical power distribution panel is structurally to rest on a floor and is supported through its frame from a ground up to be a free standing panel; rather than, being a panel that is wall mounted. The modular electrical power distribution panel, the bus bars, electrical rails and accessories are constructed as a modular unit shippable in five modular pieces or less that is tested and certified in a factory to meet requirements set by a first nationally recognized testing laboratory approval as assembled as a whole unit; and thus, eliminate a need for a second nationally recognized testing laboratory approval as the whole unit that would be required when installing the modular electrical power distribution panel, the bus bars, the electrical rails and the accessories as separate pieces at a work site.

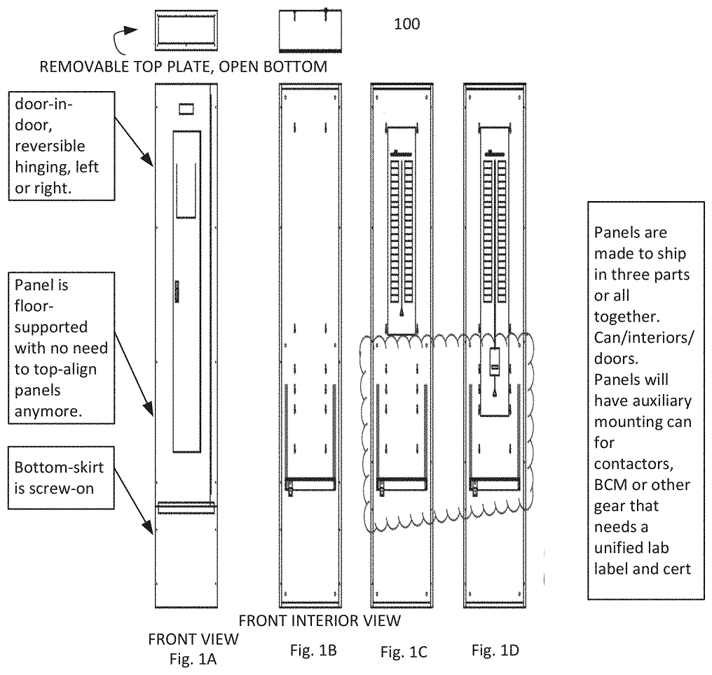

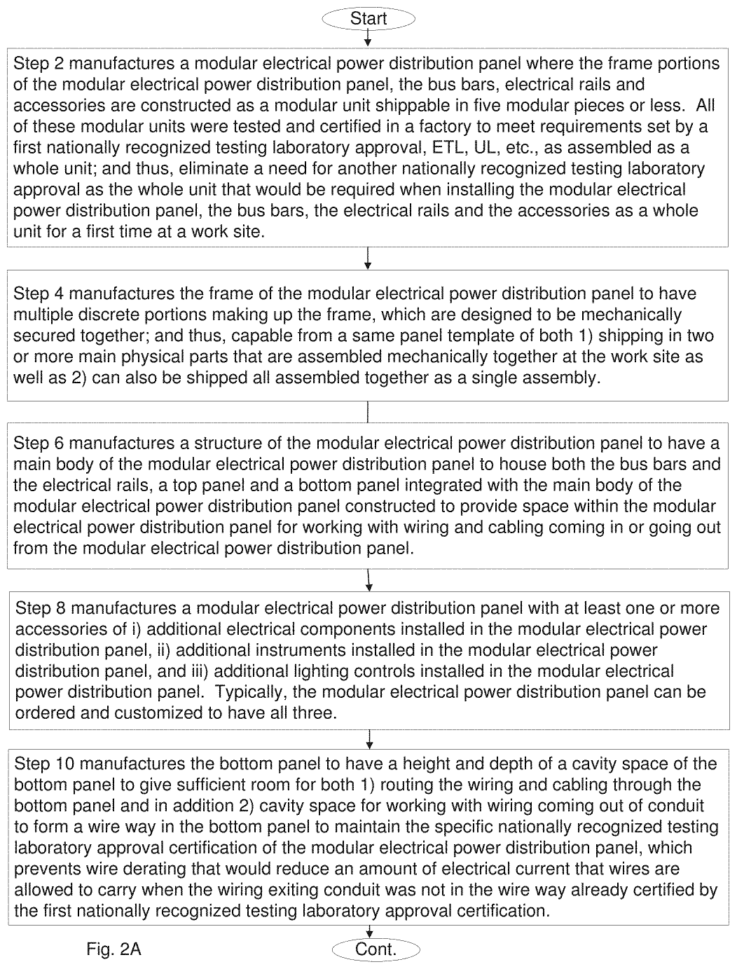

FIG. 1A illustrates a front view diagram of an embodiment of an example structure of the modular electrical power distribution panel having a main body of the modular electrical power distribution panel to house both the bus bars and the electrical rails, as well as a top panel and a bottom panel integrated with the main body of the modular electrical power distribution panel.

A type of modular electrical power distribution panel 100 for electrical branch circuit distribution panel for 600V and lower and not exceeding 400 amperes, 50 or 60 Hz operation, with a main circuit breaker or main lugs (e.g. only) is discussed. Each instance of the modular electrical power distribution panel 100 is made to ship in three main physical parts that are easily assembled in the field, but can also be shipped all assembled together as a single assembly when requested. The three physical parts making up the modular electrical power distribution panel 100 are the i) enclosure framework of the electrical power panel, ii) the interior panel housing the main and branch circuit breakers and other metering and monitoring electrical equipment installed in the interior panel in the factory, where the interior panel secures its main and branch circuit breakers into the backplane of the interior panel secures with bolts and/or screws into the enclosure framework, and iii) housing/doors mechanically attaching to the enclosure framework to covering the interior panel.

Underwriters Labs (UL) 1558 for electrical panels outlines minimum requirements for the standard for ‘Metal-Enclosed Low-Voltage Power Circuit Breaker Switchgear.’ An electrical panel can be used as an electrical load center. The electrical panel can be a metal electrical service box that accepts the feed power, such as main power, to the building and distributes electrical current and voltage through fuses and circuit breakers to the various circuits within the building. Once a person opens the door to the electrical panel, the person can access all of the circuit breakers, fuses, etc.

The enclosure framework of the electrical power panel, the interior panel and housing/doors/trim can be made identical in all ratings. When the panel is tested and shipped in three main physical parts that are easily assembled in the field and/or shipped all assembled together as a single assembly, then this panel and all of the breakers and other accessories may come certified as UL or other standards approved. Thus, all of the accessories and different physical parts of the panel will have the panel's UL approval, with no need for a field review or split approvals to be certified as UL approved because a worker assembles parts from different manufactures in the field and/or assembles different parts that have not been tested together as whole unit to be certified as UL approved as a whole unit.

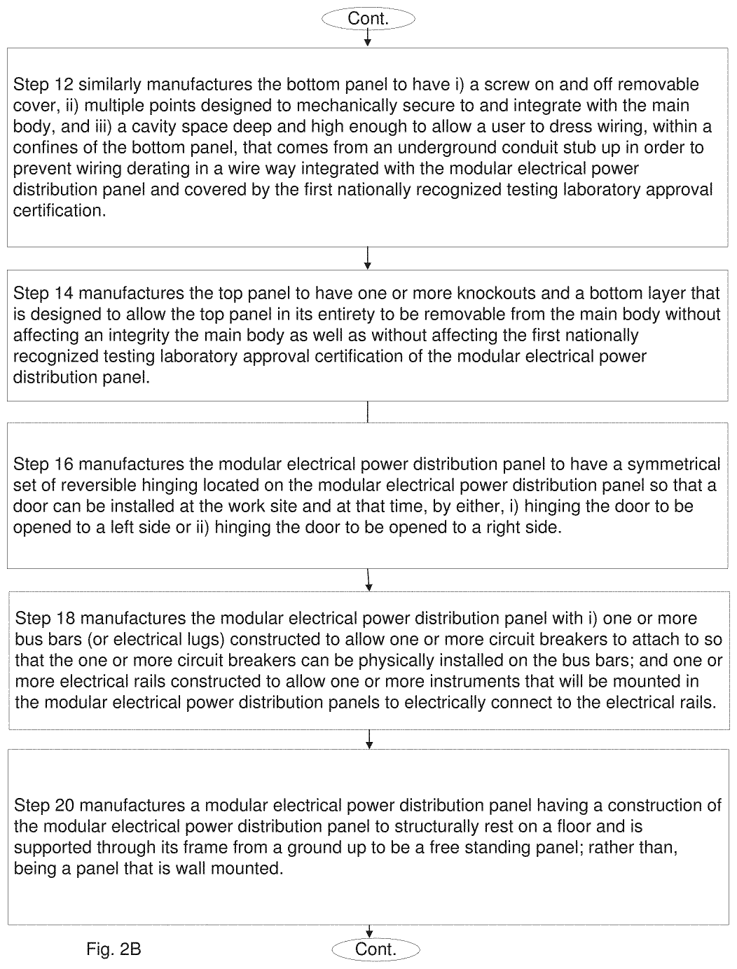

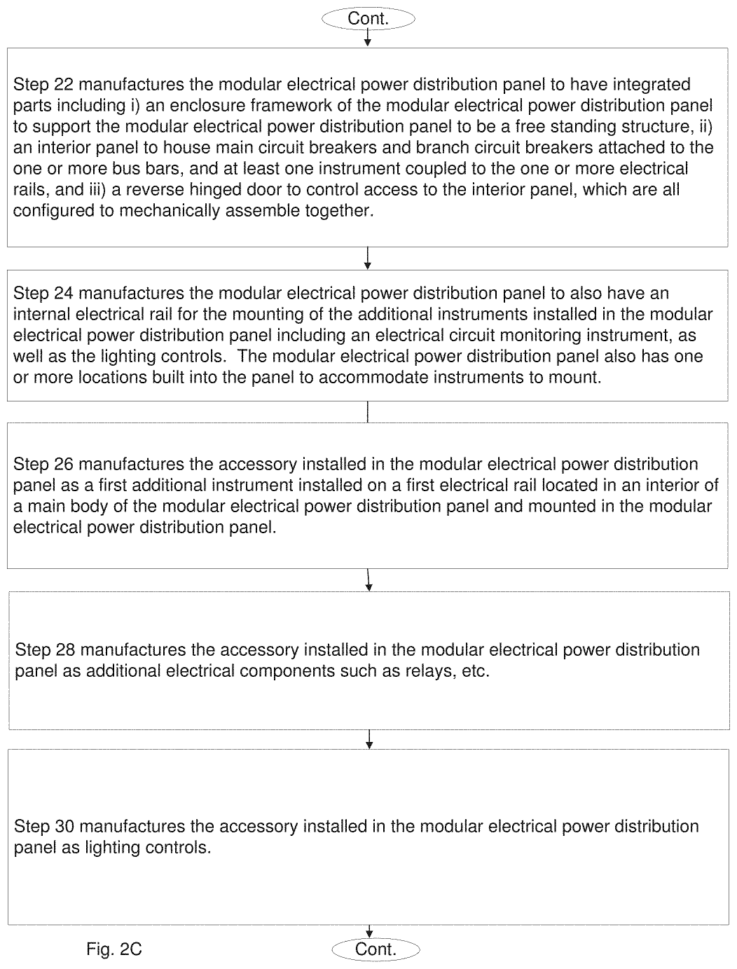

FIGS. 2A-2D illustrate a flow diagram of an embodiment of an example method of manufacturing a modular electrical power distribution panel and then installing the panel at a work site. A method of manufacturing modular electrical power distribution panel can have a number of steps as follows.

Step 2 manufactures a modular electrical power distribution panel where the frame portions of the modular electrical power distribution panel, the bus bars, electrical rails and accessories are constructed as a modular unit shippable in five modular pieces or less. All of these modular units were tested and certified in a factory to meet requirements set by a first nationally recognized testing laboratory approval, ETL, UL, etc., as assembled as a whole unit; and thus, eliminate a need for another nationally recognized testing laboratory approval as the whole unit that would be required when installing the modular electrical power distribution panel, the bus bars, the electrical rails and the accessories as a whole unit for a first time at a work site.

Step 4 manufactures the frame of the modular electrical power distribution panel to have multiple discrete portions making up the frame, which are designed to be mechanically secured together; and thus, capable from a same panel template of both 1) shipping in two or more main physical parts that are assembled mechanically together at the work site as well as 2) can also be shipped all assembled together as a single assembly.

Step 6 manufactures a structure of the modular electrical power distribution panel to have a main body of the modular electrical power distribution panel to house both the bus bars and the electrical rails, a top panel and a bottom panel integrated with the main body of the modular electrical power distribution panel constructed to provide space within the modular electrical power distribution panel for working with wiring and cabling coming in or going out from the modular electrical power distribution panel.

Step 8 manufactures a modular electrical power distribution panel with at least one or more accessories of i) additional electrical components installed in the modular electrical power distribution panel, ii) additional instruments installed in the modular electrical power distribution panel, and iii) additional lighting controls installed in the modular electrical power distribution panel. Typically, the modular electrical power distribution panel can be ordered and customized to have all three.

Step 10 manufactures the bottom panel to have a height and depth of a cavity space of the bottom panel to give sufficient room for both 1) routing the wiring and cabling through the bottom panel and in addition 2) cavity space for working with wiring coming out of conduit to form a wire way in the bottom panel to maintain the specific nationally recognized testing laboratory approval certification of the modular electrical power distribution panel, which prevents wire derating that would reduce an amount of electrical current that wires are allowed to carry when the wiring exiting conduit was not in the wire way already certified by the first nationally recognized testing laboratory approval certification.

Step 12 similarly manufactures the bottom panel to have i) a screw on and off removable cover, ii) multiple points designed to mechanically secure to and integrate with the main body, and iii) a cavity space deep and high enough to allow a user to dress wiring, within a confines of the bottom panel, that comes from an underground conduit stub up in order to prevent wiring derating in a wire way integrated with the modular electrical power distribution panel and covered by the first nationally recognized testing laboratory approval certification.

Step 14 manufactures the top panel to have one or more knockouts and a bottom layer that is designed to allow the top panel in its entirety to be removable from the main body without affecting an integrity the main body as well as without affecting the first nationally recognized testing laboratory approval certification of the modular electrical power distribution panel.

Step 16 manufactures the modular electrical power distribution panel to have a symmetrical set of reversible hinging located on the modular electrical power distribution panel so that a door can be installed at the work site and at that time, by either, i) hinging the door to be opened to a left side or ii) hinging the door to be opened to a right side.

Step 18 manufactures the modular electrical power distribution panel with i) one or more bus bars (or electrical lugs) constructed to allow one or more circuit breakers to attach to so that the one or more circuit breakers can be physically installed on the bus bars; and one or more electrical rails constructed to allow one or more instruments that will be mounted in the modular electrical power distribution panels to electrically connect to the electrical rails.

Step 20 manufactures a modular electrical power distribution panel having a construction of the modular electrical power distribution panel to structurally rest on a floor and is supported through its frame from a ground up to be a free standing panel; rather than, being a panel that is wall mounted. FIG. 1B illustrates a diagram of an embodiment of an example front interior view of the modular electrical power distribution panel structurally resting on a floor and supported through its frame from a ground up to be a free standing panel.

Step 22 manufactures the modular electrical power distribution panel to have integrated parts including i) an enclosure framework of the modular electrical power distribution panel to support the modular electrical power distribution panel to be a free standing structure, ii) an interior panel to house main circuit breakers and branch circuit breakers attached to the one or more bus bars, and at least one instrument coupled to the one or more electrical rails, and iii) a reverse hinged door to control access to the interior panel, which are all configured to mechanically assemble together.

Step 24 manufactures the modular electrical power distribution panel to also have an internal electrical rail for the mounting of the additional instruments installed in the modular electrical power distribution panel including an electrical circuit monitoring instrument, as well as the lighting controls. The modular electrical power distribution panel also has one or more locations built into the panel to accommodate instruments to mount.

Step 26 manufactures the accessory installed in the modular electrical power distribution panel as a first additional instrument installed on a first electrical rail located in an interior of a main body of the modular electrical power distribution panel and mounted in the modular electrical power distribution panel.

Step 28 manufactures the accessory installed in the modular electrical power distribution panel as additional electrical components such as relays, etc.

Step 30 manufactures the accessory installed in the modular electrical power distribution panel as lighting controls.

Step 32 manufactures a single panel template used to satisfy a range of multiple uses for the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template.

Step 34 manufactures a modular electrical power distribution panel built and assembled as a modular electrical power distribution panel constructed for an electrical rating of 600 voltage or less.

Step 36 tests the manufactured the multiple portions of the frame of the modular electrical power distribution panel, the bus bars, the electrical rails and the accessories as a whole unit to meet the requirements of a nationally recognized testing laboratory approval as the whole unit.

Step 38 has the electricians installing the modular electrical power distribution panel at a work site with its bus bars, the electrical rails and the accessories as a whole unit without needing to obtain another nationally recognized testing laboratory approval as the whole unit.

Referring back to FIG. 1A, the modular electrical power distribution panel 100 offers a significant increase for installation speed, correctness, and commonality of most parts. Other aspects of the modular electrical power distribution panel 100 also protect the panel to remain clean during extended construction, allow conduit installation in the field with factory-defined templates, allow parts that are static, in some current panels, to be removed from the panel, substituted in different variants and options in the standard panel manufacturing set up for the modular electrical power distribution panel 100, and easy work at table level.

The modular electrical power distribution panel 100 has i) a wire way with a removable bottom cover, ii) wide enough dimensions for the interior of the enclosure framework of the electrical power panel, and a top removable panel to allow increased accessibility to the panel's working parts and allows for branch wiring operation at a 100% rating. The MEPP also has a factory-provided DIN rail for the mounting of circuit monitoring, as aspect that is hand-wired in the field today, and factory-wired or plug-and-play in the field.

The MEPP may be used in the electrical power distribution industry/general electrical construction.

FIG. 1C illustrates a diagram of an embodiment of an example front interior view of the modular electrical power distribution panel with integrated parts including i) an enclosure framework of the modular electrical power distribution panel to support the modular electrical power distribution panel to be a free standing structure and ii) an interior panel to house 1) main circuit breakers and branch circuit breakers attached to the one or more bus bars, and 2) internal electrical rails.

The three parts making up the modular electrical power distribution panel 100 i) the enclosure framework of the electrical power panel, ii) the interior panel housing the main and branch circuit breakers and other metering and monitoring electrical equipment, and the reverse hinged door are configured mechanically to assemble quite easily in the field when shipped as three discrete parts. The three physical parts making up the modular electrical power distribution panel 100 are modular.

The construction of the modular electrical power distribution panel 100 is structurally supported from the ground up, with dimensions set in height to be meet a standard height for the electrical circuit breakers that falls with the electrical code requirements speeds physical installation by eliminating wall-mounting. The MEPP dimensions set in height for the electrical circuit breakers to be easily serviced and installed by a worker standing.

A possible sequence of steps for the installation can be as follows.

In a step, a worker may mount the structure/exterior/enclosure of the modular electrical power distribution panel 100 in a four to six bolt operation. The installation is much faster than some previous electrical panels. The interior panel is prefabricated with 4 to 6 bolt-in captive screws to mechanically connect to the enclosure framework. Screws, bolts, and/or other mechanical securing mechanisms can be used as well. The worker installing the modular electrical power distribution panel 100 has little to no need to level the MEPP, as it free standing and rests on the floor. This is the same pattern on all of the different variations of the modular electrical power distribution panels 100 being installed. The modular electrical power distribution panel 100 may use shims and/or small leveling feet to make small leveling adjustments. The modular electrical power distribution panel 100 is constructed to be self-standing/ floor-supported, integrated panel assembly, and set with dimensions in height so that there is no need to top-align panels anymore. The MEPP is constructed to be floor-supported, not wall-supported.

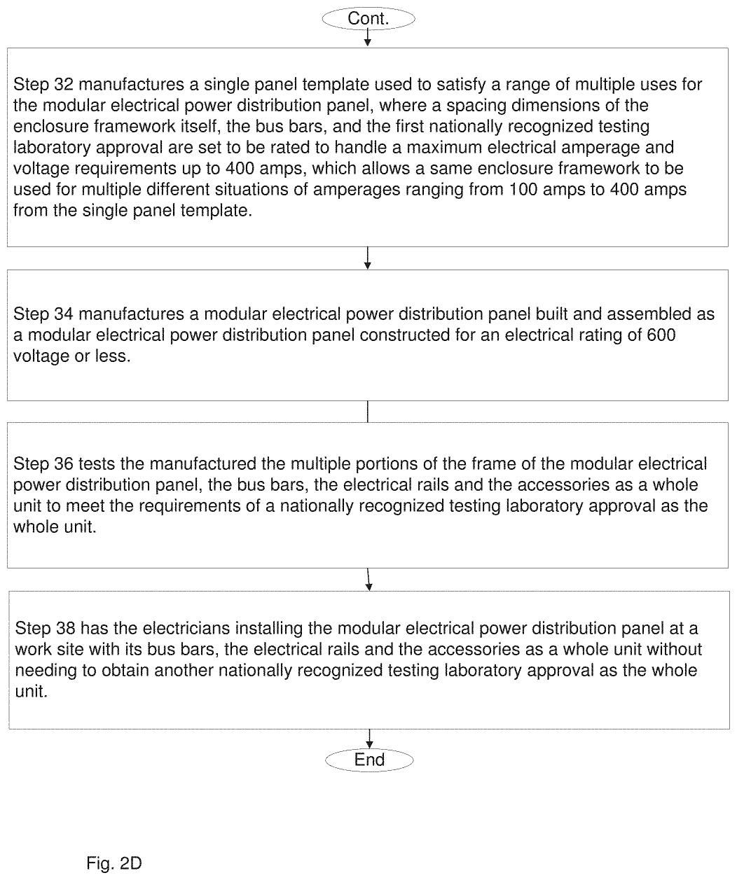

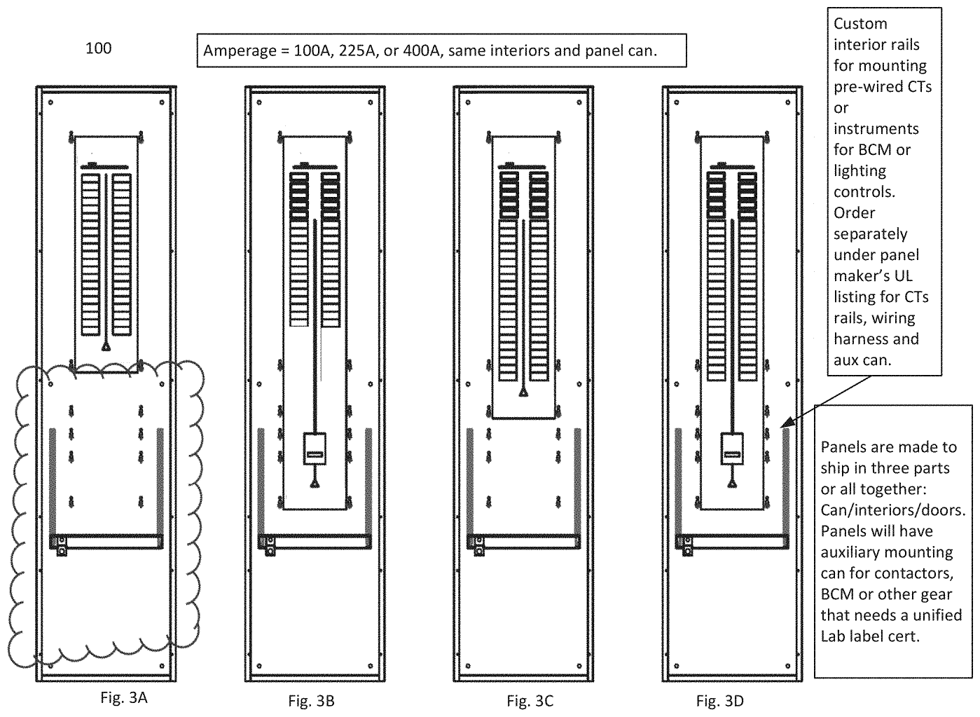

In a step, a worker may mount panel interiors of the modular electrical power distribution panel 100 in a four to six bolt operation. This is the same pattern on all of the different variations of the modular electrical power distribution panels 100 being installed. FIG. 3B illustrates a block diagram of an embodiment of an example single panel template used to manufacture the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template. FIG. 3C also illustrates a block diagram of an embodiment of an example single panel template used to manufacture the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template. However, in FIG. 3C the circuit breakers attaching to the bus bar are rated for 400 amps and need to be spaced further apart than the circuit breakers rated for 100 amps in FIG. 3B. The 400 amp rated circuit breakers stretch much further down into the main housing in FIG. 3C than the 100 amp rated circuit breakers in FIG. 3B. Both FIGS. 3B and 3C have the same interior panel for the bus bar installed with the 4 to 6 bolt/screw operation.

In a step, a worker may mount instruments for branch circuit/feeder monitoring of the modular electrical power distribution panels 100 being installed. The DIN rail allows the mounting different varieties of external meters, electronics or accessories specific to that panel instance, and its loads and applications.

FIG. 1D illustrates a diagram of an embodiment of an example front interior view of the modular electrical power distribution panel that has one or more electrical rails for the mounting of instruments installed in the modular electrical power distribution panel including an electrical circuit monitoring instrument. The interior DIN rail(s) allows for customization on components in the panel for mounting pre-wired CTs or instruments for BCM or lighting controls. Each different type of accessory for lighting control, contactors, BCM, etc. can be mounted and tested in the factory to give the entire panel a unified UL rating. The metering/monitoring DIN rails built into the internal side of the interior panel for electrical connections combined with the mounting slots in the external side of the interior panel allow for mechanically attaching to the individual metering/monitoring components to the interior panel and electrically connecting them via the DIN rails.

In a step, a worker may electrically terminate feeder and branch circuit wiring within the open space interior behind the removable cover in the electrical power panel; and thus, not have the feeder and branch circuit wiring be electrically derated. The bottom-removable cover is screw-on. The bottom-removable cover section may have, for example, a 15″ height and opens into a 6″ depth cavity, which give sufficient room for working with the wiring and cabling. Behind the bottom-removable cover, the open space forms a wire way in the electrical power panel. Because this open space is within the single assembly of the electrical power panel the bottom of the panel maintains its UL listing of the MEPP, prevents wire derating on stubups and wiring exiting conduit going through the wire way of behind the bottom-removable cover onto the interior panel housing the main and branch circuit breakers and other metering and monitoring electrical equipment installed in the MEPP in the factory. Note, when a conduit is connected to the bottom of the panel and its wire way, then a grounding bushing on metallic conduits may be installed. Again, the modular electrical power distribution panel 100 provides an integrated wire way under the panel's UL listing for underground conduit stub ups to prevent wiring derating. The MEPP is quite a bit larger than typical power panels.

The bottom wire way section of the MEPP, covered by the removable bottom cover prevents wiring derating when a wire way is placed below or above the panel to intercept and manage incoming feeders or circuits. The bottom wire way section of the MEPP, having space to contain external wires in its wire way, is integrated with the enclosure framework to make a single underwriter labs approved single assembly.

In a step, a worker may mate the housing of the enclosure mechanically to the door. The worker may mount the door itself with a symmetrical set of reversible hinging so that the door can be installed in the field site and at that time, either, hinge the door to be opened to the left side or hinge the door to be opened to the right side.

FIG. 3A illustrates a block diagram of an embodiment of an example frame of the modular electrical power distribution panel constructed to have multiple discrete portions making up the frame, which are designed to be mechanically secured together; and thus, capable from a same panel template of both 1) shipping in two or more main physical parts that are assembled mechanically together at the work site as well as 2) can also be shipped all assembled together as a single assembly.

The enclosure framework has a top panel that is mechanically removable. The top panel has a laser-etched grid pattern for KO layout of conduits being connected to the modular electrical power distribution panel 100 through the top panel. The top panel can have pre-punched holes for easy connection of conduits to the top panel and allow their wires to pass through into the modular electrical power distribution panel 100 to the circuit breakers and other electrical components on the internal panel.

A top or bottom wiring entry into the panel, with MCB or MLO with a same interior configuration. The spacing dimensions of the enclosure framework itself are set to be rated to handle the maximum electrical amperage and voltage requirements, which allow the same the enclosure framework to be used for multiple different situations including amperages of 100 A, 225 A, and/or 400 A. Also, this allows the internal panel to have a same width dimensions for different amperages of 100 A, 225 A, and/or 400 A and merely two templates to accommodate all of the circuit breaker spacing standards of 1 inch between circuit breakers or 1.25 inches between circuit breakers. (See FIGS. 3B and 3C) The width and depth of the available space in the enclosure leading up to and behind the internal panel are set to provide adequate wiring pulling space up to 1×500 MCM or paralleled 4/0.

Overall, the panel's framework structure, mountings, internal structure, and electrical structure are essentially identical in size and electrical connections to support ranges of 100-400A and 120/208V, 277/480V, 330/575V, 208V and 480V.

The top panel's and the bottom panel are integrated with the main body of the panel to allow all of top, bottom, and side-mounted wire entry, metering and accessory mounting.

The MEPP starts with a set of structural and physical assemblies for the purpose of standardizing parts and speeding up an installation process in the field along with the ultimate approval to use the electrical panel and all of its components in operation in the building that the MEPP is installed in. In addition, components related to the MEPP, such as metering, electronics, breakers, cabling types and instrumentation can be added, changed from existing, or plug-and-play adapted in the factory and tested to receive UL approval to use the electrical panel and all of its components in operation as a whole unit.

Again, the physical parts of the panel are made to ship in three parts or all together and maintain their factory assembled and tested UL approved rating granted and conveyed at the factory. Assembling and mechanically and electrically connecting up all of circuit breakers in the internal panel, the individual metering/monitoring components to the interior panel, the bottom wire way section of the MEPP integrated the remainder of enclosure framework of the electrical power panel, the top removable section, the housing/doors mechanically attaching to the enclosure framework to covering the interior panel, all are individually laboratory safety approved and when assembled and tested at the factory are laboratory safety approved as an integrated system, even when shippable as three discrete parts that can be assembled in the field. The three parts maintain their factory assembled and tested UL approved rating; versus, separately manufactured and ordered panel parts and accessories from separate panel makers and equipment makers with individual UL approvals for their particular component, panel parts, CT's, rails, wiring harness, but not UL approved as a whole unit. Accordingly, the modular electrical power distribution panel 100 can be field mounted and is independent of voltage or current rating (the current systems vary depending on current and voltage).

FIG. 3D illustrates a block diagram of an embodiment of an example a modular electrical power distribution panel built and assembled for an electrical rating of 600 voltage or less with at least one or more accessories of i) additional electrical components installed in the modular electrical power distribution panel, ii) additional instruments installed in the modular electrical power distribution panel, and iii) additional lighting controls installed in the modular electrical power distribution panel.

A main circuit breaker opens the current paths to all of the bus bars in that distribution panel. Each bus bar has connections to allow circuit breakers to attach so that the circuit breakers are installed physically back to back on the same bus bar. For example, the bus bar may have tab connections strip to attach circuit breakers onto each side of the bus bar. The strip of tab connections may face in one direction on one side of the bus bar and the tab connections face in the other direction on the opposite side of the bus bar. Likewise, one strip of bus bar may be formed with a strip of tab connections to attach circuit breakers and that strip of bus bar may be bent in half to form the strip of tab connections facing in one direction on one side of the bus bar and the tab connections that face in the other direction. The tabs for the connection to circuit breakers from the bus bar may be offset to allow for a better physical connection. Access to the circuit breakers may have both a front door access as well as a rear door access. The circuit breakers may be physically installed on the bus bar both 1) side by side on the strip of tab connections and 2) then also back to back in the physical space of the distribution panel. Many other ways to make the connection of the bus bar to the circuit breaker exists.

In electrical power distribution, the bus bar is a strip or bar of copper, brass, aluminum, or other metal that conducts electricity within the distribution panel. The bus bar's main purpose is to conduct electricity and be a structural member onto which circuit breakers leading to electrical load may connect to. Bus bars may be connected to each other and to electrical apparatus by bolted, clamp, or welded connections.

The distribution panel splits the electrical supply into separate circuits at one location via the bus bars. Each bus bar allows a new electrical circuit protected by its own circuit breaker to branch off anywhere along the route of the bus bar. The panel may also have one or more fuses or other electrical interrupts installed in the panel to split the electrical supply into separate circuits/electrical loads.

In an embodiment, electrical power from the utility transformer may feed 480 volts three phase AC power to the main circuit breaker and the bus bars in the distribution panel. There may be multiple “Hot” electrical bus bars in the panel. These bus bars provide power to the circuits. By varying how many bus bars a circuit breaker connects to, that determines if it is providing 120 volt, 240 volt or 480 volt electricity to a circuit for an electrical load. For example, single pole circuit breakers provide 120 volts and connect to just one hot bus bar. double pole circuit breakers provide 240 volts to a circuit and plug into both hot bus bars. The electrical current leaves the distribution panel through the power wires attached to the circuit breaker and goes on its way to the various electrical loads.

Once the power leaves the electrical distribution panel through the power wires and does its work through the electrical load (light bulb, motor, etc.) the electrical current returns back to the service panel through the Neutral circuit white wire which is connected to the Neutral bar. The Neutral bar is attached to the service panel and collects all the neutral white wires from the various circuits. The bar connects to the main circuit neutral wire where it returns the current back to the electric utility company's transformer, usually the source of the electricity. The circuit breakers connect to the Hot bus bars as well as the Neutral bar.

While some specific embodiments of the invention have been shown, the invention is not to be limited to these embodiments. For example, most functions performed by electronic hardware components may be duplicated by software emulation. Thus, a software program written to accomplish those same functions may emulate the functionality of the hardware components in input-output circuitry. The type of cabinets may vary, etc. The invention is to be understood as not limited by the specific embodiments described herein, but only by scope of the appended claims.

We claim:

1. An apparatus, comprising:
a modular electrical power distribution panel built and assembled as a modular electrical power distribution panel constructed for an electrical rating of 600 voltage or less with at least one or more accessories of i) additional electrical components installed in the modular electrical power distribution panel, ii) additional instruments installed in the modular electrical power distribution panel, and iii) additional lighting controls installed in the modular electrical power distribution panel;
where the modular electrical power distribution panel further includes
one or more bus bars (or electrical lugs) constructed to allow one or more circuit breakers to attach to so that the one or more circuit breakers can be physically installed on the bus bars;
one or more electrical rails constructed to allow one or more instruments that will be mounted in the modular electrical power distribution panels to electrically connect to the electrical rails;
where a construction of the modular electrical power distribution panel is structurally to rest on a floor and is supported through its frame from a ground up to be a free standing panel; rather than, being a panel that is wall mounted; and
where the modular electrical power distribution panel, the bus bars, electrical rails and accessories are constructed as a modular unit shippable in five modular pieces or less that is tested and certified in a factory to meet requirements set by a first nationally recognized testing laboratory approval as assembled as a whole unit; and thus, eliminate a need for a second nationally recognized testing laboratory approval as the whole unit that would be required when installing the modular electrical power distribution panel, the bus bars, the electrical rails and the accessories as separate pieces at a work site.

2. The apparatus of claim 1, where the frame of the modular electrical power distribution panel is constructed to have multiple discrete portions making up the frame, which are designed to be mechanically secured together; and thus, capable from a same panel template of both 1) shipping in two or more main physical parts that are assembled mechanically together at the work site as well as 2) can also be shipped all assembled together as a single assembly.

3. The apparatus of claim 1, where the modular electrical power distribution panel also has a first electrical rail for the mounting of the additional instruments installed in the modular electrical power distribution panel including an electrical circuit monitoring instrument, as well as the lighting controls, where the panel has one or more locations built into the electrical power distribution panel to accommodate instruments to mount.

4. The apparatus of claim 1, where the modular electrical power distribution panel has integrated parts including i) an enclosure framework of the modular electrical power distribution panel to support the modular electrical power distribution panel to be a free standing structure, ii) an interior panel to house main circuit breakers and branch circuit breakers attached to the one or more bus bars, and at least one instrument coupled to the one or more electrical rails, and iii) a reverse hinged door to control access to the interior panel, which are all configured to mechanically assemble together.

5. The apparatus of claim 1, where a structure of the modular electrical power distribution panel consists of a main body of the modular electrical power distribution panel to house both the bus bars and the electrical rails, a top panel and a bottom panel integrated with the main body of the modular electrical power distribution panel constructed to provide space within the modular electrical power distribution panel for working with wiring and cabling coming in or going out from the modular electrical power distribution panel.

6. The apparatus of claim 5, where the bottom panel has a height and depth of a cavity space of the bottom panel to give sufficient room for both 1) routing the wiring and cabling through the bottom panel and in addition 2) cavity space for working with wiring coming out of conduit to form a wire way in the bottom panel to maintain the specific nationally recognized testing laboratory approval certification of the modular electrical power distribution panel, which prevents wire derating that would reduce an amount of electrical current that wires are allowed to carry when the wiring exiting conduit was not in the wire way already certified by the first nationally recognized testing laboratory approval certification.

7. The apparatus of claim 5, where the bottom panel has i) a screw on and off removable cover, ii) multiple points designed to mechanically secure to and integrate with the main body, and iii) a cavity space deep and high enough to allow a user to dress wiring within a confines of the bottom panel that comes from an underground conduit stub up in order to prevent wiring derating in a wire way integrated with the modular electrical power distribution panel and covered by the first nationally recognized testing laboratory approval certification.

8. The apparatus of claim 1, where a single panel template is used to manufacture the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template.

9. The apparatus of claim 1, where the modular electrical power distribution panel has a symmetrical set of reversible hinging located on the modular electrical power distribution panel so that a door can be installed at the work site and at that time, by either, i) hinging the door to be opened to a left side or ii) hinging the door to be opened to a right side.

10. The apparatus of claim 1, where the accessory is a first additional instrument installed on a first electrical rail located in an interior of a main body of the modular electrical power distribution panel and mounted in the modular electrical power distribution panel.

11. A method of manufacturing, comprising:
manufacturing a modular electrical power distribution panel built and assembled as a modular electrical power distribution panel constructed for an electrical rating of 600 voltage or less with at least one or more accessories of i) additional electrical components installed in the modular electrical power distribution panel, ii) additional instruments installed in the modular electrical power distribution panel, and iii) additional lighting controls installed in the modular electrical power distribution panel;
where the modular electrical power distribution panel further includes one or more bus bars (or electrical lugs) constructed to allow one or more circuit breakers to attach to so that the one or more circuit breakers can be physically installed on the bus bars;
one or more electrical rails constructed to allow one or more instruments that will be mounted in the modular electrical power distribution panels to electrically connect to the electrical rails;
where a construction of the modular electrical power distribution panel is structurally to rest on a floor and is supported through its frame from a ground up to be a free standing panel; rather than, being a panel that is wall mounted; and
where the modular electrical power distribution panel, the bus bars, electrical rails and accessories are constructed as a modular unit shippable in five modular pieces or less that is tested and certified in a factory to meet requirements set by a first nationally recognized testing laboratory approval as assembled as a whole unit; and thus, eliminate a need for a second nationally recognized testing laboratory approval as the whole unit that would be required when installing the modular electrical power distribution panel, the bus bars, the electrical rails and the accessories as separate pieces at a work site.

12. The method of claim 11, further comprising:
manufacturing the frame of the modular electrical power distribution panel to have multiple discrete portions making up the frame, which are designed to be mechanically secured together; and thus, capable from a same panel template of both 1) shipping in two or more main physical parts that are assembled mechanically together at the work site as well as 2) can also be shipped all assembled together as a single assembly.

13. The method of claim 11, further comprising:
manufacturing the modular electrical power distribution panel to also have a first electrical rail for the mounting of the additional instruments installed in the modular electrical power distribution panel including an electrical circuit monitoring instrument, as well as the lighting controls, where the modular electrical power distribution panel has one or more locations built into the panel to accommodate instruments to mount.

14. The method of claim 11, further comprising:
manufacturing the modular electrical power distribution panel to have integrated parts including i) an enclosure framework of the modular electrical power distribution panel to support the modular electrical power distribution panel to be a free standing structure, ii) an interior panel to house main circuit breakers and branch circuit breakers attached to the one or more bus bars, and at least one instrument coupled to the one or more electrical rails, and iii) a reverse hinged door to control access to the interior panel, which are all configured to mechanically assemble together.

15. The method of claim 11, further comprising:
manufacturing a structure of the modular electrical power distribution panel to have a main body of the modular electrical power distribution panel to house both the bus bars and the electrical rails, a top panel and a bottom panel integrated with the main body of the modular electrical power distribution panel constructed to provide space within the modular electrical power distribution panel for working with wiring and cabling coming in or going out from the modular electrical power distribution panel.

16. The method of claim 15, further comprising:
manufacturing the bottom panel to have a height and depth of a cavity space of the bottom panel to give sufficient room for both 1) routing the wiring and cabling through the bottom panel and in addition 2) cavity space for working with wiring coming out of conduit to form a wire way in the bottom panel to maintain the specific nationally recognized testing laboratory approval certification of the modular electrical power distribution panel, which prevents wire derating that would reduce an amount of electrical current that wires are allowed to carry when the wiring exiting conduit was not in the wire way already certified by the first nationally recognized testing laboratory approval certification, and
manufacturing the top panel to have one or more knockouts and a bottom layer that is designed to allow the top panel in its entirety to be removable from the main body without affecting an integrity the main body as well as without affecting the first nationally recognized testing laboratory approval certification of the modular electrical power distribution panel.

17. The method of claim 15, further comprising:
manufacturing the bottom panel to have i) a screw on and off removable cover, ii) multiple points designed to mechanically secure to and integrate with the main body, and iii) a cavity space deep and high enough to allow a user to dress wiring, within a confines of the bottom panel, that comes from an underground conduit stub up in order to prevent wiring derating in a wire way integrated with the modular electrical power distribution panel and covered by the first nationally recognized testing laboratory approval certification.

18. The method of claim 11, further comprising:
manufacturing a single panel template used to satisfy a range of multiple uses for the modular electrical power distribution panel, where a spacing dimensions of the enclosure framework itself, the bus bars, and the first nationally recognized testing laboratory approval are set to be rated to handle a maximum electrical amperage and voltage requirements up to 400 amps, which allows a same enclosure framework to be used for multiple different situations of amperages ranging from 100 amps to 400 amps from the single panel template.

19. The method of claim 11, further comprising:
manufacturing the modular electrical power distribution panel to have a symmetrical set of reversible hinging located on the modular electrical power distribution panel so that a door can be installed at the work site and at that time, by either, i) hinging the door to be opened to a left side or ii) hinging the door to be opened to a right side.

20. The method of claim 11, further comprising:
manufacturing the accessory installed in the modular electrical power distribution panel as a first additional instrument installed on a first electrical rail located in an interior of a main body of the modular electrical power distribution panel and mounted in the modular electrical power distribution panel.
